(19) United States
(12) Patent Application Publication
(10) Pub. No.: US 2014/0034701 A1
(43) Pub. Date: Feb. 6, 2014

(54) DRIVER

(71) Applicant: HITACHI KOKI CO., LTD., Tokyo (JP)

(72) Inventor: Yoshiichi KOMAZAKI, Hitachinaka (JP)

(73) Assignee: HITACHI KOKI CO., LTD., Tokyo (JP)

(21) Appl. No.: 13/953,111

(22) Filed: Jul. 29, 2013

(30) Foreign Application Priority Data
Jul. 31, 2012 (JP) 2012-170370

(51) Int. Cl. B25C 1/04

(52) U.S. Cl. CPC B25C 1/047
USPC 227/8

(57) ABSTRACT

A driver includes: a driver blade which is driven by a pressure of fluid supplied to a main cylinder to strike a fastener, thereby driving the fastener into a target object; a push lever which is movably provided in the main body and reciprocably moves between a releasing position at which fluid supply to the main cylinder is enabled and a restricting position at which fluid supply to the main cylinder is disabled; a sub-piston which abuts on the push lever and holds the push lever at the restricting position; and a trigger which is provided in the main body and controls the fluid supply to the main cylinder, and a stroke of the push lever is changed when the fluid is supplied to the main cylinder.

### CROSS-REFERENCE TO RELATED APPLICATION

The present application claims priority from Japanese Patent Application No. 2012-170370 filed on Jul. 31, 2012, the content of which is hereby incorporated by reference into this application.

### TECHNICAL FIELD OF THE INVENTION

The present invention relates to a driver which drives a fastener such as a nail or a screw into a target object such as a timber or a drywall.

### BACKGROUND OF THE INVENTION

FIG. 9 shows an example of a conventional driver. The driver shown in FIG. 9 is a nail driver which drives fasteners such as nails into a target object, and it includes a main body 101, a handle 102 extending from a side surface of the main body 101 in a direction intersecting with an axis of the main body 101, a nose section 103 extending from a lower end of the main body 101 in a direction along the axis of the main body 101, and a magazine 104 bridging between the nose section 103 and the handle 102.

Though not shown, a cylinder is provided in the main body 101, and a driver blade reciprocably driven by a pressure of compressed air is housed in the cylinder. When a trigger 122 is operated in the state where predetermined conditions are satisfied, the compressed air is supplied into the cylinder and the driver blade is driven by the pressure of the compressed air, so that the head of the nail is struck.

The nose section 103 has a guide tube 133 which holds the nail fed from the magazine 104 at a predetermined position and guides the nail so as to straighten the driving direction of the nail. A push lever 140 surrounding the guide tube 133 is provided around the guide tube 133. The push lever 140 reciprocably moves in a longitudinal direction of the sheet of FIG. 9 and is always biased in a downward direction of the sheet of FIG. 9. Indeed, the push lever 140 has a bottom dead center defined by a tail cover 145 shown in FIG. 10. Specifically, the push lever 140 is coupled to a rod 152 biased in a downward direction by a spring in a syringe case 150 shown in FIG. 10, but a tip end of the rod 152 abuts on the tail cover 145 fixed to the main body 101. When the push lever 140 is pressed to the target object 100, it moves in an upward direction (moves up) relative to the main body 101, while compressing the spring. In other words, the main body 101 moves in a downward direction (moves down) relative to the push lever 140, while compressing the spring.

Next, the operation of the nail driver shown in FIG. 9 will be described. As shown in FIG. 9, the tip end of the push lever 140 is made to abut on the target object 100. In this state, the push lever 140 just abuts on the target object 100, and is not pressed thereto. When the push lever 140 is located at an illustrated position, a distance between the tip end of the guide tube 133 and the tip end of the push lever 140 is X (mm).

Next, as shown in FIG. 11, the main body 101 is pushed in the downward direction to press the push lever 140 to the target object 100. Then, the push lever 140 moves in the upward direction relative to the main body 101, and the main body 101 is moved in the downward direction relative to the push lever 140. More specifically, the push lever 140 moves in the upward direction relative to the main body 101 by X (mm), and the main body 101 moves in the downward direction relative to the push lever 140 by X (mm). When the trigger 122 is operated when the push lever 140 is located at an illustrated position, the compressed air is supplied into the cylinder, the driver blade is pushed down, and the head of the nail held by the guide tube 133 is struck. Then, as shown in FIG. 12, the main body 101 is moved in the upward direction by the reaction of the driving, so that the tip end of the push lever 140 is separated from the target object 100. The push lever 140 separated from the target object 100 returns to the original position by the bias of the spring. An example of the above-described nail driver is described in Japanese Patent Application Laid-Open Publication No. 2009-83091.

### SUMMARY OF THE INVENTION

Nails 200 to be driven into a target object by the nail driver described above are housed in the magazine 104 shown in FIG. 9 and others, in a state of being welded to wires 201 at equal intervals and wound into roll form as shown in FIG. 13A and FIG. 13B. Herein, when the nails 200 are to be driven in the above-described manner, the next nail 200 adjacent to the nail 200 being driven is held by pawls (not shown) provided in the nail driver. More specifically, the driver blade drives the nails 200 one by one, while forcibly breaking the coupling of the adjacent nails. At this time, a part of the wire 201 which has coupled the adjacent nails is rubbed between an outer peripheral surface of the driver blade and an inner peripheral surface of the guide tube 133 (FIG. 11 and others) to produce sparks in some cases. Also, the outer peripheral surface of the driver blade and the inner peripheral surface of the guide tube 133 are sometimes rubbed with each other to produce sparks. Furthermore, the nail 200 pushed out by the driver blade and the inner peripheral surface of the guide tube 133 are rubbed with each other to produce sparks in some cases.

The graph shown in FIG. 14 shows the displacements of the piston (driver blade), the main body 101 (FIG. 9 and others), and the push lever 140 (FIG. 9 and others) when the nail driver is operated in the above-described manner. For making the relationship of the respective displacement states easily understood, the downward direction is expressed as positive (plus) for the amount of displacement of the piston, and the upward direction is expressed as positive (plus) for the amount of displacement of the main body 101 and the push lever 140. Also, X (mm) shown in FIG. 9 is set to 5 mm.

With reference to the graph shown in FIG. 14, the main body 101 starts to move upward simultaneously with the start of the downward movement of the piston. At this time, since the push lever 140 has moved up 5 mm relative to the main body 101, it is after the amount of upward movement of the main body 101 reaches 5 mm that the push lever 140 starts to move upward.

It is after 0.013 seconds from the start of the downward movement of the piston that the amount of upward movement of the main body 101 reaches 5 mm. Therefore, the tip end of the push lever 140 separates from the target object 100 after 0.013 seconds from the start of the downward movement of the piston. On the other hand, the piston does not reach the bottom dead center at the time after 0.013 seconds from the start of downward movement. More specifically, the tip end of the push lever 140 separates from the target object 100 before the piston (driver blade) reaches the bottom dead center. Therefore, there is fear that the sparks produced for the above-described reasons are flown from a space (FIG. 12) between the tip end of the push lever 140 and the target object 100.

An object of the present invention is to prevent the sparks from flying from the space between a tip end of a push lever and a target object.

A driver according to the present invention includes: a main body; a main cylinder provided in the main body; a movable body which is reciprocably provided in the main cylinder and strikes a fastener; a push lever which is provided in the main body so as to be movable along an axis of the main body and reciprocably moves between a releasing position at which fluid supply to the main cylinder is enabled and a restricting position at which fluid supply to the main cylinder is disabled; a positioning member which abuts on the push lever and holds the push lever at the restricting position; and a trigger which is provided in the main body and controls the fluid supply to the main cylinder. The movable body is driven by the pressure of the fluid supplied to the main cylinder to strike the fastener, thereby driving the fastener into the target object. When the fluid is supplied to the main cylinder, the stroke of the push lever is changed.

According to the present invention, it is possible to prevent the sparks from flying from the space between the push lever and the target object.

### BRIEF DESCRIPTIONS OF THE DRAWINGS

FIG. 1 is aside view of a nail driver showing the state where the push lever is at a restricting position;

FIG. 2 is a cross-sectional view of a nail driver;

FIG. 3 is a side view of the nail driver showing the state where the push lever is at a releasing position;

FIG. 4 is an enlarged cross-sectional view taken along the line A-A shown in FIG. 1;

FIG. 5 is a side view of the nail driver showing the state where a second clearance is formed between the push lever and the positioning member;

FIG. 6 is a side view of the nail driver showing the state where the push lever and the positioning member abut again on each other;

FIG. 7 is a diagram showing the state of displacement of the main piston, the main body and the push lever;

FIG. 8 is a side view showing a modified example of the nail driver;

FIG. 9 is a side view of a conventional nail driver showing the state where the push lever is at a restricting position;

FIG. 10 is an enlarged cross-sectional view taken along the line A-A shown in FIG. 9;

FIG. 11 is a side view of the conventional nail driver showing the state where the push lever is at the releasing position;

FIG. 12 is a side view of the conventional nail driver showing the state where the push lever has separated from a target object;

FIG. 13A is a top view of nails housed in a magazine;

FIG. 13B is a side view of the nails housed in the magazine; and

FIG. 14 is a diagram showing the state of displacement of the piston, the main body and the push lever.

### DESCRIPTIONS OF THE PREFERRED EMBODIMENTS

An example of a driver to which the present invention is applied will be described in detail with reference to drawings. The driver to be described here is a nail driver using compressed air as driving force.

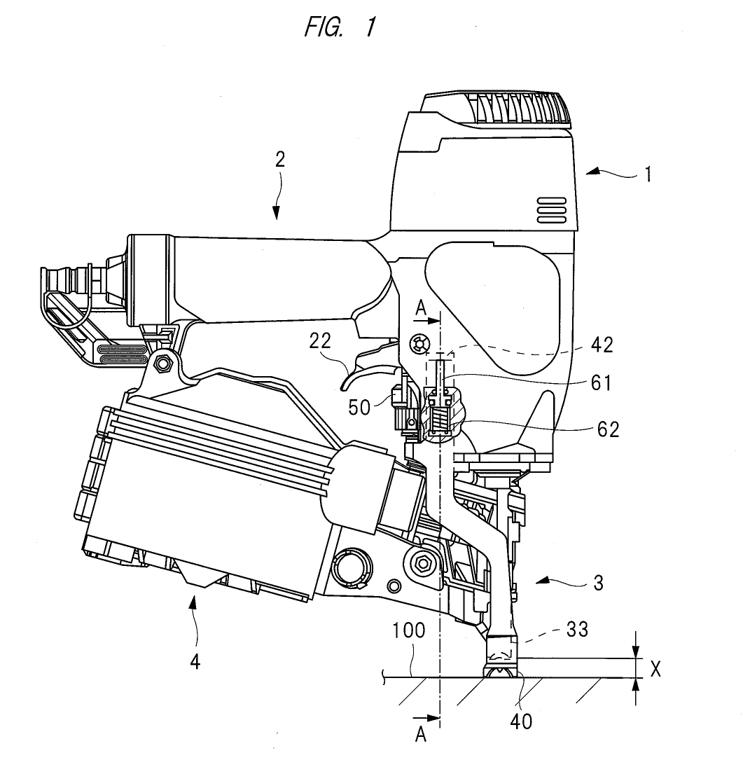

The nail driver shown in FIG. 1 has a main body 1, a handle 2 extending from a side surface of the main body 1 in a direction intersecting with an axis of the main body 1, a nose section 3 extending from a lower end of the main body 1 in a direction along the axis of the main body 1, and a magazine 4 bridging between the nose section 3 and the handle 2.

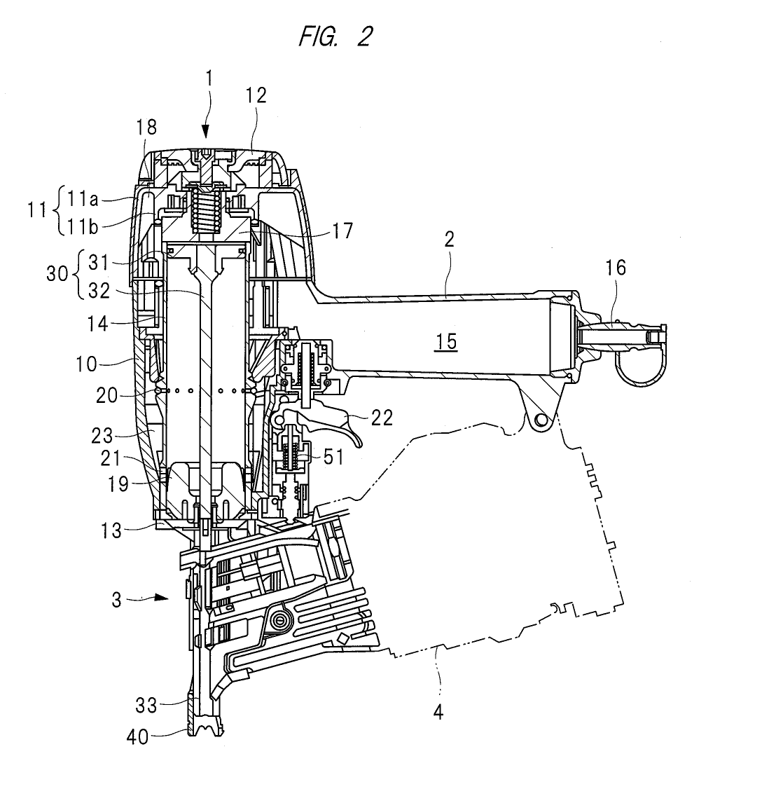

As shown in FIG. 2, the main body 1 has a housing 10, a guide part 11, a head cover 12, and an undercover 13. The housing 10 has a hollow structure. The guide part 11 is consecutively provided in an opening on one end side of the housing 10, and the head cover 12 is placed on the guide part 11. Also, the undercover 13 is provided on an opening on the other end side of the housing 10. Furthermore, a main cylinder 14 having a cylindrical shape is housed in the housing 10. An upper part of the main cylinder 14 protrudes through the opening on one end side of the housing 10 and enters the guide part 11.

The handle 2 is a part gripped by a worker who uses the nail driver, and a pressure accumulation chamber 15 is provided therein. One end of the handle 2 is fixed to the housing 10 and a plug 16 is provided at the other end of the handle 2. The plug 16 is an air pipe communicating with the pressure accumulation chamber 15, and is connected to a compressor (not shown) through an air hose (not shown).

The guide part 11 has an outer cylinder 11a and an inner cylinder 11b, and the outer cylinder 11a surrounds the inner cylinder 11b. A main valve 17 which controls the communication between the pressure accumulation chamber 15 and the main cylinder 14 is disposed above the main cylinder 14 inside the guide part 11 so as to be vertically movable. Also, an expansion chamber 18 is provided between the outer cylinder 11a and the inner cylinder 11b of the guide part 11.

On the other hand, when paying attention to the lower side of the main cylinder 14, a damper 19 is disposed from a lower part of the main cylinder 14 over the undercover 13. The damper 19 is formed in an approximately cylindrical shape from an elastic rubber. Also, a check valve 20 is provided at the approximate center of the main cylinder 14, and a return path 21 is provided below the check valve 20.

A driver blade 30 as a movable body is housed in the main cylinder 14 so as to be reciprocably moved. The driver blade 30 has a main piston 31 and a shaft part 32 connected to the main piston 31, and is driven to reciprocate by the pressure of the fluid supplied to and discharged from the main cylinder 14 to strike a fastener such as a nail (not shown).

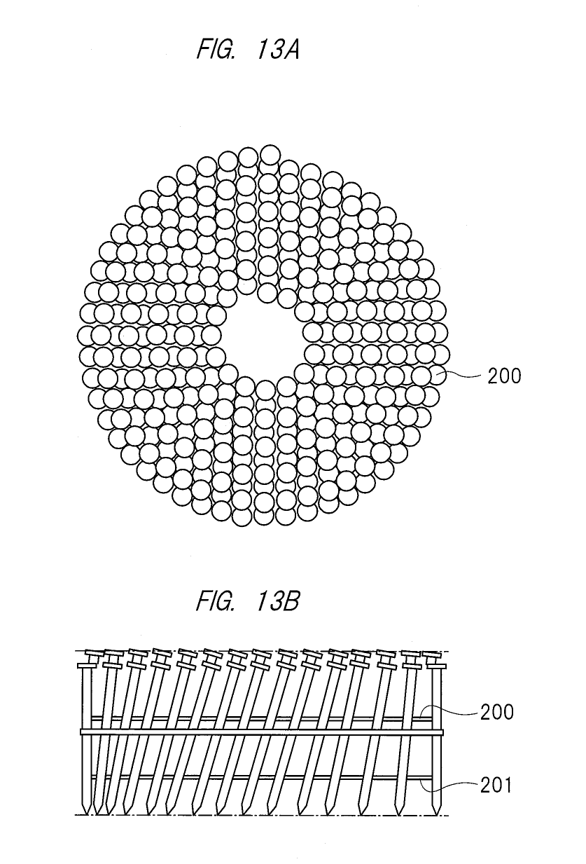

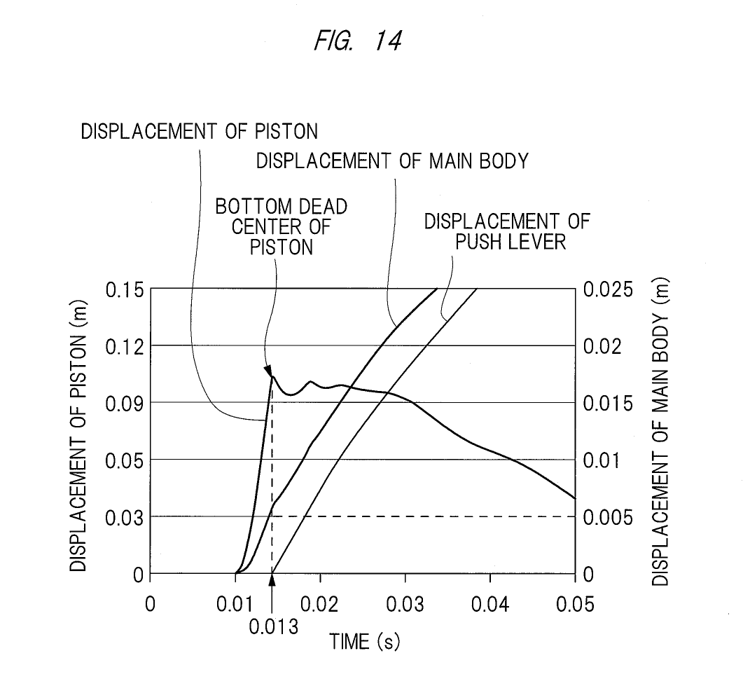

The magazine 4 is a container in which a large number of nails 200 coupled as shown in FIG. 13A and FIG. 13B are housed. The magazine 4 is provided with a feeding mechanism which sequentially feeds a large number of housed nails 200 to the nose section 3.

The nose section 3 has a guide tube 33 which holds the nail fed by the feeding mechanism at a predetermined position and guides the nail so as to straighten the driving direction of the nail.

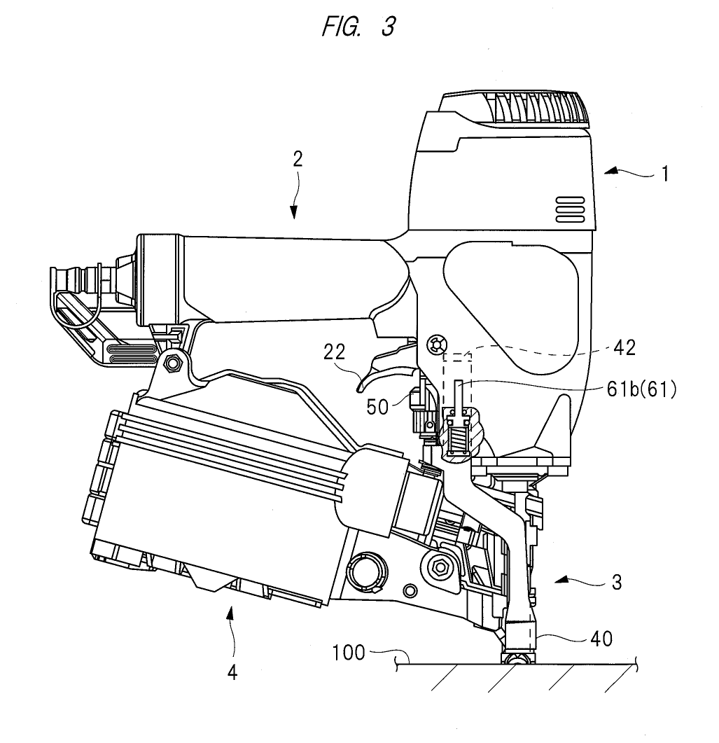

As shown in FIG. 1 and FIG. 2, the push lever 40 is provided around the guide tube 33. The push lever 40 is provided in the main body 1 so as to be movable along the axis of the main body 1. Specifically, the push lever 40 can reciprocate between the position shown in FIG. 1 and the position shown in FIG. 3, and when the trigger 22 is operated when the push lever 40 is at the position shown in FIG. 3, the compressed air is supplied into the main cylinder 14 shown in FIG. 2. On the other hand, when the push lever 40 is at the position shown in FIG. 1, the compressed air is not supplied into the main cylinder 14 shown in FIG. 2 even if the trigger 22 is operated. More specifically, the push lever 40 can reciprocate between the position at which fluid supply to the main cylinder 14 is enabled (releasing position) and a position at which fluid supply to the main cylinder 14 is disabled (restricting position). In other words, the push lever 40 has a function of controlling the supply of the compressed air to the main cylinder 14 and also a function as a safety system to control the operation of the driver blade 30.

In the case where the nail driver is used in the direction shown in FIG. 1 and FIG. 3, when the push lever 40 is pressed to the target object 100, the push lever 40 is displaced from an under side to an upper side (moves upward) of the sheet relative to the main body 1, and moves from the restricting position to the releasing position. When the pressing to the target object 100 is released, the push lever 40 is displaced from an upper side to an under side (moves downward) of the sheet relative to the main body 1, and moves from the releasing position to the restricting position. Note that the nail driver can be used in the direction different from that shown in FIG. 1 and FIG. 3. For example, the nail driver can be used in the direction rotated counterclockwise by 90 degrees relative to the direction shown in FIG. 1 and FIG. 3. In this case, when the push lever 40 is pressed to the target object 100, it is displaced from a right side to a left side of the sheet relative to the main body 1 and moves from the restricting position to the releasing position, and when the pressing to the target object 100 is released, the push lever 40 is displaced from a left side to a right side of the sheet relative to the main body 1 and moves from the releasing position to the restricting position. In the following descriptions, it is presupposed that the nail driver is used in the direction shown in FIG. 1 and FIG. 3.

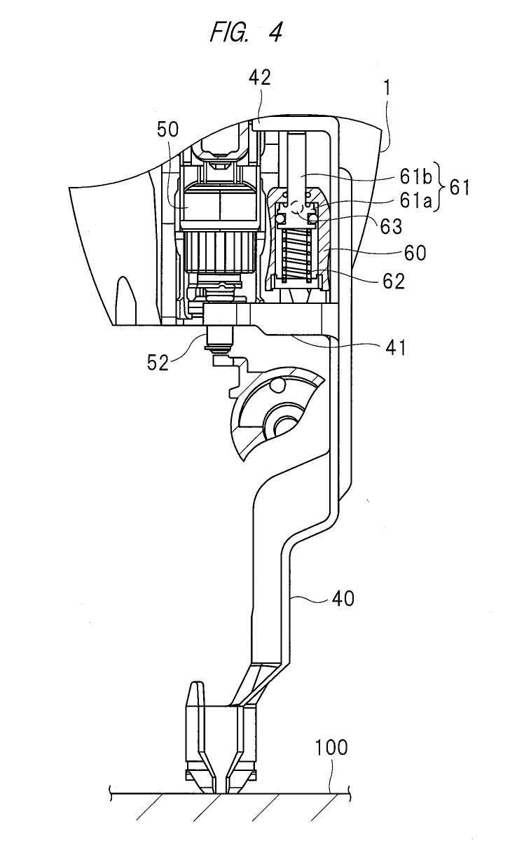

As shown in FIG. 4, a first engagement part 41 and a second engagement part 42 protruding toward a lateral side are formed by integral molding on the upper part of the push lever 40. Also, a lower part (tip end part) of the push lever 40 is formed to have an approximately cylindrical shape surrounding the guide tube 33 (FIG. 2). Of course, the tip end part of the push lever 40 does not have a complete cylindrical shape, but it partly surrounds the guide tube 33. Note that the illustration of the guide tube 33 is omitted in FIG. 4.

The first engagement part 41 and the second engagement part 42 of the push lever 40 are provided at two different positions along the moving direction of the push lever 40. Specifically, the second engagement part 42 is provided at the upper end of the push lever 40, and the first engagement part 41 is provided at a position lower than that of the second engagement part 42 (position closer to the tip end of the push lever 40 compared with the second engagement part 42).

A tip end of a bias member (rod 52) which is biased in a downward direction of the sheet by a push lever spring 51 (FIG. 2) incorporated in a syringe case 50 is engaged with the first engagement part 41. Specifically, a through hole having female threads formed on an inner peripheral surface thereof is formed in the first engagement part 41, and male threads formed on an outer peripheral surface of the rod 52 are screw-coupled to the female threads. Therefore, the push lever 40 is always biased toward the restricting position.

The syringe case 50 is held in a rotatable and vertically movable manner. When the syringe case 50 is rotated around an axis of the rod 52, it moves in an upward direction of the sheet of FIG. 4, and when the syringe case 50 is reversely rotated around the axis, it moves in a downward direction of the sheet of FIG. 4. By making the syringe case 50 move up and down in this manner, the distance between the syringe case 50 and the first engagement part 41 of the push lever 40 is changed, and the depth to drive the nail into the target object 100 is thus changed.

On the other hand, the movement of the push lever 40 in the downward direction of the sheet is restricted by a positioning mechanism provided adjacent to the syringe case 50. The positioning mechanism is made up of a sub-cylinder 60 adjacent to the syringe case 50, a positioning member (sub-piston 61) housed in the sub-cylinder 60, and an elastic body (sub-spring 62). The sub-piston 61 has a flange part 61a disposed in the sub-cylinder 60 and a shaft part 61b extending from the flange part 61a. One end of the shaft part 61b is connected to an upper surface of the flange part 61a and the other end thereof protrudes to the outside of the sub-cylinder 60.

The flange part 61a of the sub-piston 61 is housed in the sub-cylinder 60 so as to be movable in upward and downward directions, and the sub-spring 62 is housed in a space (lower chamber) between a lower surface of the flange part 61a and a bottom surface of the sub-cylinder 60 in the sub-cylinder 60. On the other hand, the shaft part 61b protrudes to the outside of the sub-cylinder 60 through a ceiling surface of the sub-cylinder 60, and abuts on the second engagement part 42 of the push lever 40 from an under side of the sheet of FIG. 4. More specifically, the push lever 40 is biased by the rod 52 from an upper side toward a lower side of the sheet of FIG. 4 and is supported by the sub-piston 61 from a lower side of the sheet of FIG. 4, and the bottom dead center of the push lever 40 is determined by the sub-piston 61.

Furthermore, a communication hole 63 communicating with a space (upper chamber) between an upper surface of the flange part 61a of the sub-piston 61 and the ceiling surface of the sub-cylinder 60 is formed in the side surface of the sub-cylinder 60, and the upper chamber and a return chamber 23 (FIG. 2) are communicated through this communication hole 63.

Next, the operation of the nail driver according to the present embodiment will be described. As shown in FIG. 1, the tip end of the push lever 40 is made to abut on the target object 100. In this state, the push lever 40 just abuts on the target object 100 and is not pressed thereto. More specifically, the push lever 40 is in a stand-by state and at a restricting position. When the push lever 40 is at the restricting position, the tip end of the shaft part 61b of the sub-piston 61 shown in FIG. 4 abuts on the second engagement part 42. At this time, the distance between the tip end of the guide tube 33 and the tip end of the push lever 40 is X (mm) (FIG. 1).

Next, as shown in FIG. 3, the main body 1 is pushed downward to press the push lever 40 to the target object 100. Then, the push lever 40 moves upward relative to the main body 1, and the main body 1 moves downward relative to the push lever 40. More specifically, the push lever 40 moves from the restricting position to the releasing position. In other words, the push lever 40 moves to the top dead center. Specifically, the push lever 40 moves in the upward direction relative to the main body 1 by X (mm), and the main body 1 moves in the downward direction relative to the push lever 40 by X (mm). In conjunction with the upward movement of the push lever 40 relative to the main body 1 by X (mm), the second engagement part 42 of the push lever 40 also moves upward by X (mm) from the tip end of the shaft part 61b of the sub-piston 61. More specifically, the push lever 40 separates from the sub-piston 61, and a first clearance of X (mm) is formed between the push lever 40 (second engagement part 42) and the sub-piston 61 (shaft part 61b). When the trigger 22 is operated in this state, the compressed air is supplied to the main cylinder 14 shown in FIG. 2, the main piston 31 (driver blade 30) is pushed down, and the head of the nail (not shown) held by the guide tube 33 is struck.

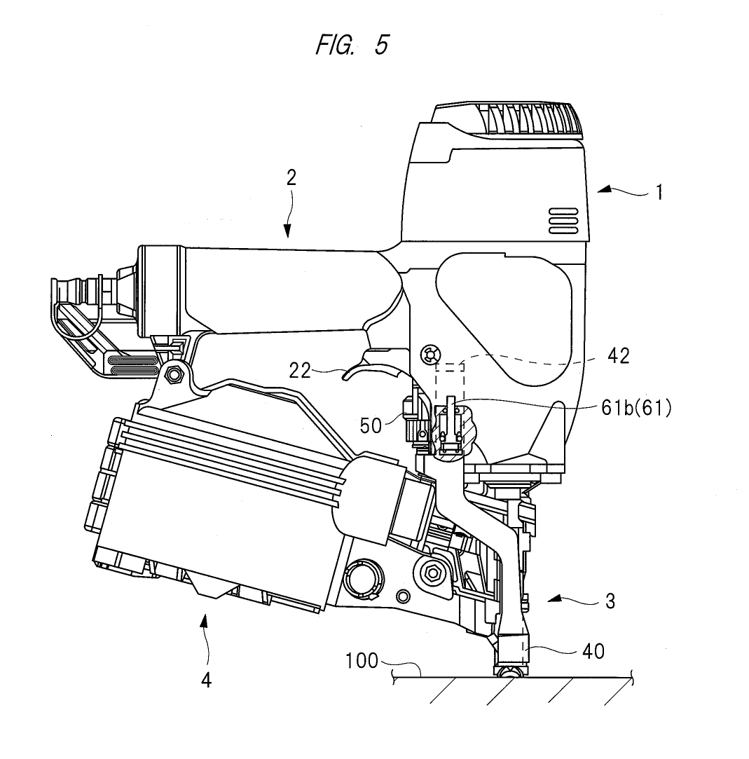

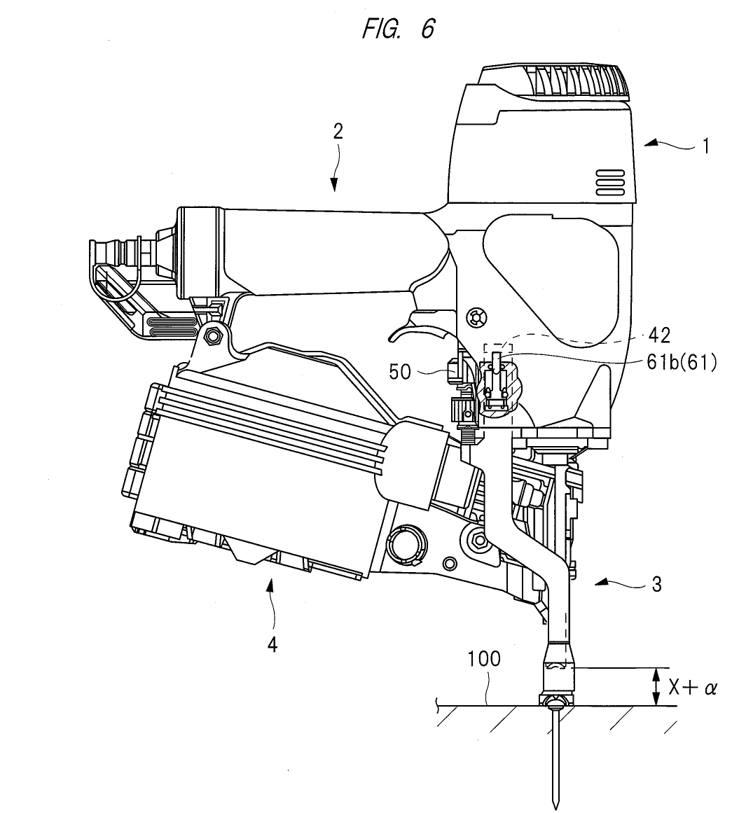

At this time, a part of the compressed air supplied to the return chamber 23 in conjunction with the downward movement of the main piston 31 (driver blade 30) shown in FIG. 2 flows in the upper chamber of the sub-cylinder 60 through the communication hole 63 shown in FIG. 4, and the pressure in the upper chamber is increased. Thus, the sub-piston 61 moves downward against the bias of the sub-spring 62. Then, as shown in FIG. 5, the sub-piston 61 separates from the push lever 40, and the clearance between the push lever 40 (second engagement part 42) and the sub-piston 61 (shaft part 61b) is enlarged. More specifically, the first clearance (X mm) between the push lever 40 and the sub-piston 61 present before the start of the driving operation is enlarged to a larger second clearance (X+α mm). In other words, simultaneously with or almost simultaneously with the start of the upward movement of the main body 1 in response to the reaction of the driving, the clearance between the main body 1 and the push lever 40 is enlarged by just α (mm). Therefore, the tip end of the shaft part 61b of the sub-piston 61 which determines the bottom dead center of the push lever 40 does not abut on the second engagement part 42 of the push lever 40 until the amount of upward movement of the main body 1 reaches X+α (mm). More specifically, the bottom dead center of the push lever 40 in the driving operation is located at a position lower than the bottom dead center before the driving operation. In other words, the tip end of the shaft part 61b of the sub-piston 61 abuts again on the second engagement part 42 of the push lever 40 (FIG. 6) at the time when the amount of upward movement of the main body 1 reaches X+α (mm). Therefore, the tip end of the push lever 40 abuts on the target object 100 until the amount of upward movement of the main body 1 reaches X+α (mm). In the nail driver of the present embodiment, X (mm) mentioned above is set to 5 mm and α (mm) mentioned above is also set to 5 mm.

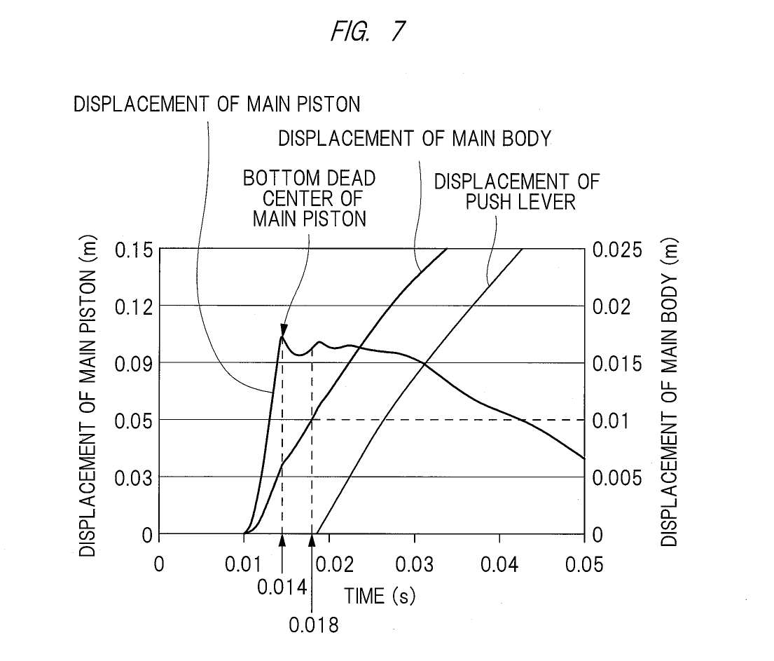

The graph in FIG. 7 shows the state of displacement of the main piston 31 (FIG. 2), the main body (FIG. 1 and others) and the push lever 40 (FIG. 1 and others) when the nail driver of the present embodiment is operated in the above-described manner. Note that, for making the relationship of the respective displacement states easily understood, the downward direction is expressed as positive (plus) for the amount of displacement of the main piston 31 (driver blade 30), and the upward direction is expressed as positive (plus) for the amount of displacement of the main body 1 and the push lever 40.

With reference to the graph shown in FIG. 7, the main body 1 starts to move upward simultaneously with the downward movement of the main piston 31. At this time, the second clearance of 10 mm is present between the main body 1 (sub-piston 61) and the push lever 40 (second engagement part 42) (see FIG. 5). Therefore, it is after the amount of upward movement of the main body 1 reaches 10 mm that the push lever 40 starts to move upward.

It is after 0.018 seconds from the start of the downward movement of the main piston 31 that the amount of upward movement of the main body 1 reaches 10 mm. Therefore, the push lever 40 is kept abutting on the target object 100 for 0.018 seconds from the start of the downward movement of the main piston 31. On the other hand, the main piston 31 reaches the bottom dead center after 0.014 seconds from the start of downward movement. More specifically, the push lever 40 separates from the target object 100 after the main piston 31 (driver blade 30) reaches the bottom dead center.

As described above, in the nail driver according to the present embodiment, simultaneously with or almost simultaneously with the start of the downward movement of the main piston 31, the clearance between the main body 1 and the push lever 40 is enlarged. More specifically, the amount of stroke of the push lever 40 with respect to the main body 1 is changed before and after the driving operation. In other words, simultaneously with or almost simultaneously with the start of the driving operation, the bottom dead center of the push lever 40 is moved to a position lower than that before the start of the driving operation, and it returns to the position before the start of the driving operation when the driving operation is completed. Therefore, in the driving operation, the push lever 40 can be moved to the position lower than that before the driving operation. Consequently, the push lever 40 is kept abutting on the target object 100 at least until the main piston 31 (driver blade 30) passes through the bottom dead center. Accordingly, there is no fear that the sparks produced for the above-described reasons are flown from the space between the push lever 40 and the target object 100.

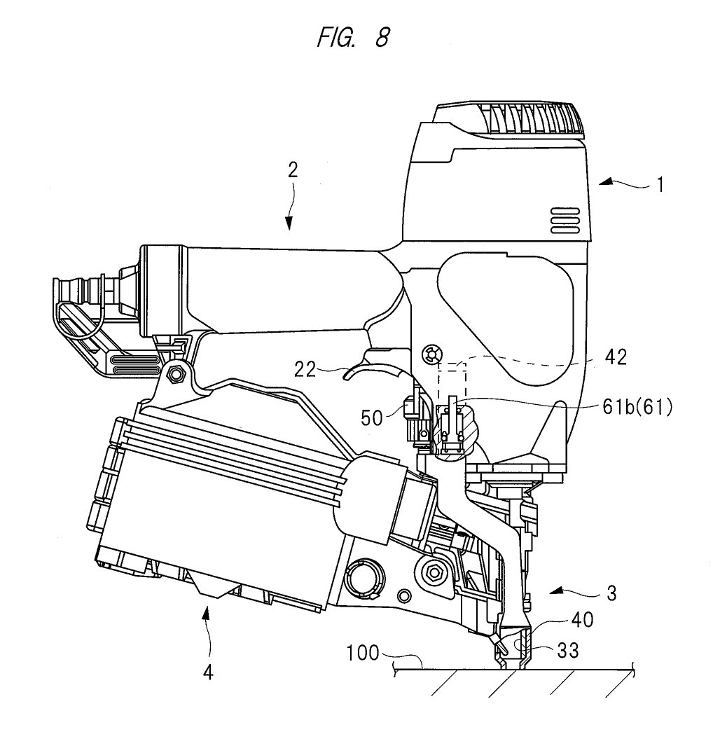

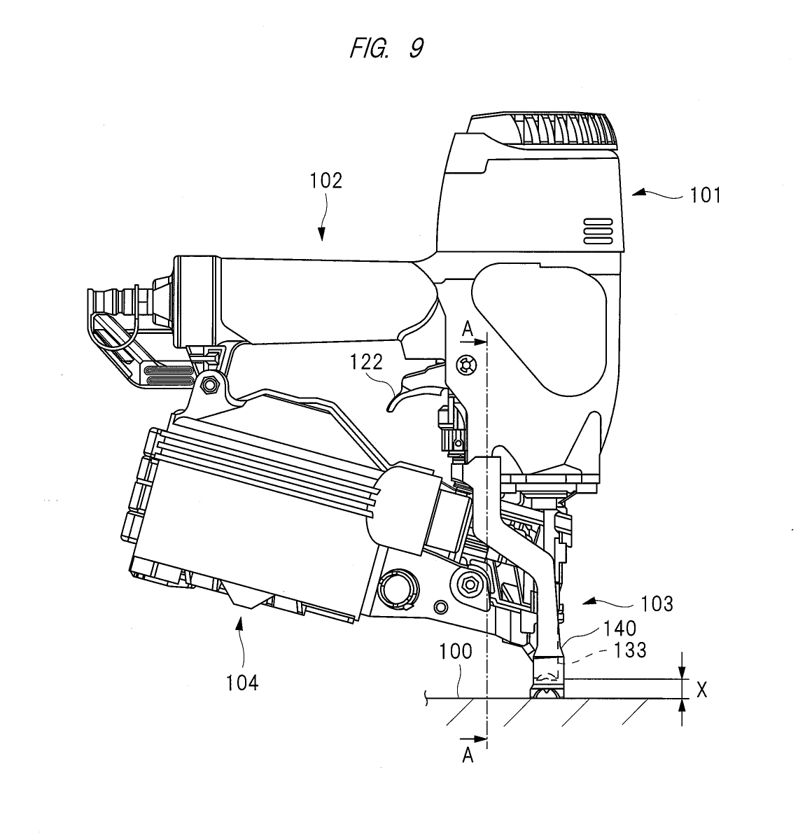

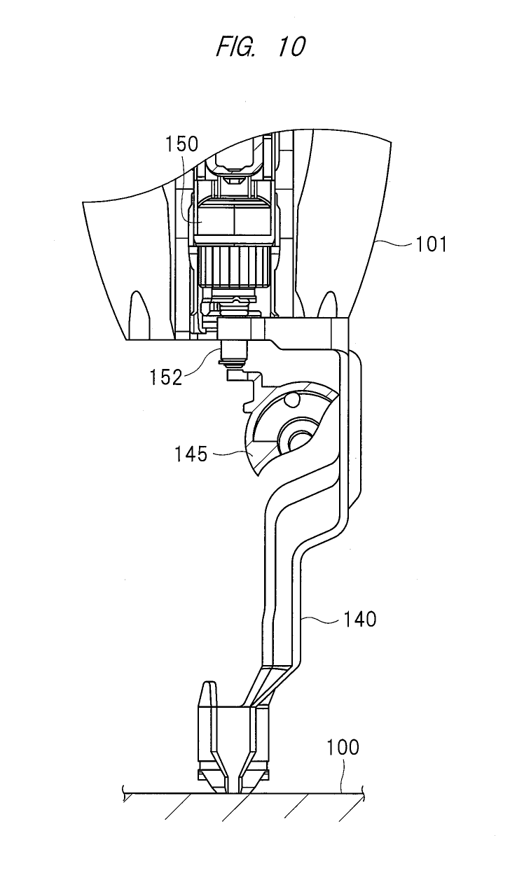

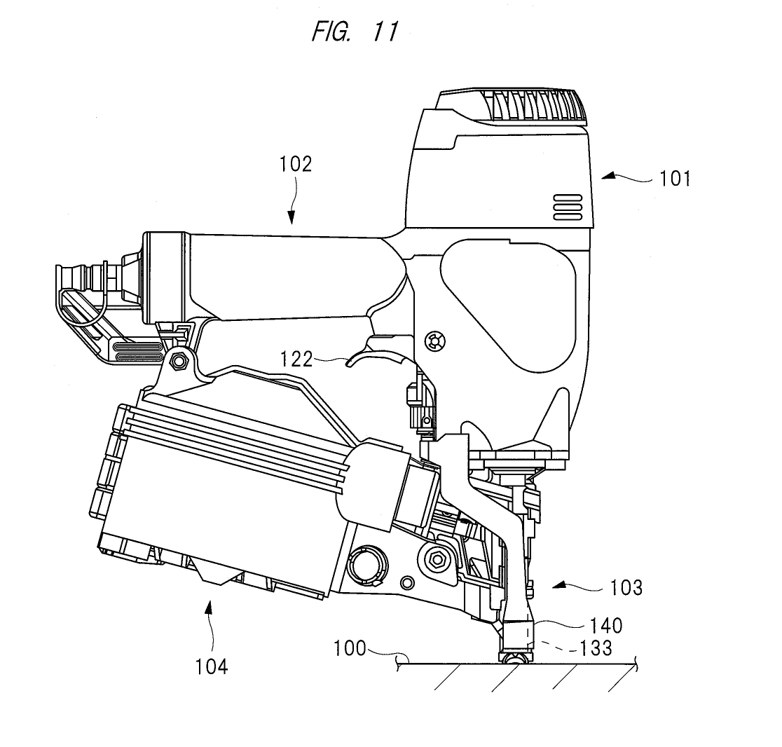

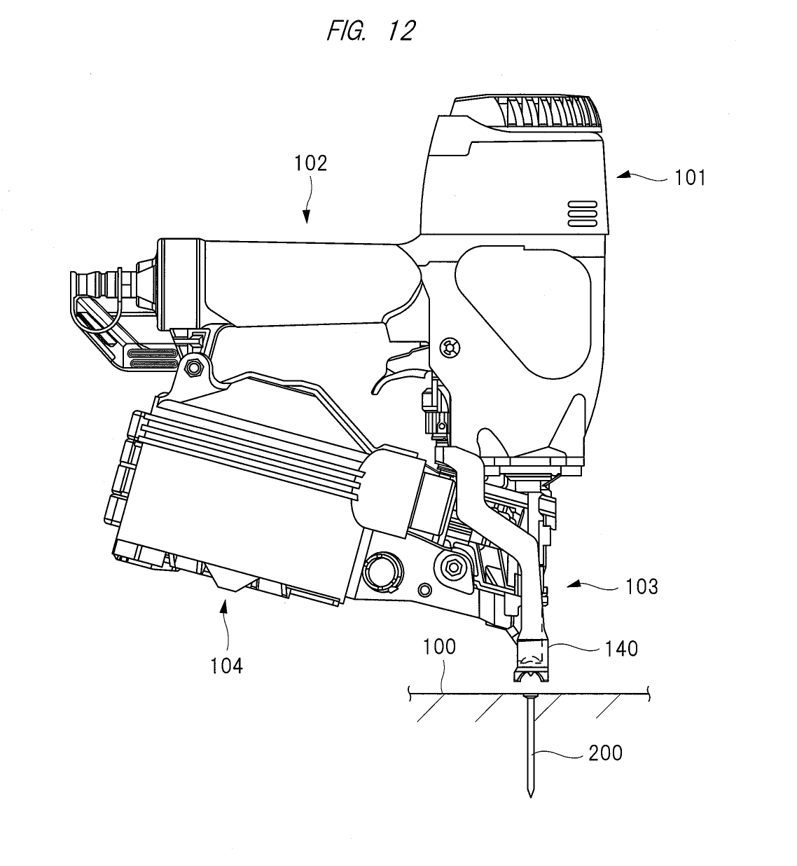

The present invention is not limited to the above-described embodiment, and can be modified in various manners within the scope of the invention. For example, in the embodiment shown in FIG. 8, the tip end part of the push lever 40 is formed in a complete cylindrical shape surrounding the entire circumference of the guide tube 33. Furthermore, the opening at the tip end of the push lever 40 has approximately the same diameter as the opening (discharge port) at the tip end of the guide tube 33. In this embodiment, the nail is guided by both of the guide tube 33 and the push lever 40. Furthermore, the push lever 40 is kept abutting on the target object 100 at least until the driver blade 30 (FIG. 2) passes through the bottom dead center. Therefore, compared with the embodiment in which the nail is guided by only the guide tube 33, the period of time when the nail is being guided becomes longer, and the certainty of the guide is enhanced.

Also, a driver which uses fluid pressure generated by the combustion of gas or powder as a drive force of the movable body in place of the pressure of the compressed air supplied from a compressor is also included in the scope of the present invention.

What is claimed is:

1. A driver having a movable body which is driven by a pressure of fluid supplied to a main cylinder to strike a fastener, thereby driving the fastener into a target object, comprising:
a main body in which the main cylinder is housed;
the movable body which is reciprocably provided in the main cylinder;
a push lever which is provided in the main body so as to be movable along an axis of the main body and reciprocably moves between a releasing position at which fluid supply to the main cylinder is enabled and a restricting position at which fluid supply to the main cylinder is disabled;
a positioning member which abuts on the push lever and holds the push lever at the restricting position; and
a trigger which is provided in the main body and controls the fluid supply to the main cylinder,
wherein a stroke of the push lever is changed when the fluid is supplied to the main cylinder.

2. The driver according to claim 1,
wherein, when the positioning member separates from the push lever, the stroke of the push lever is changed.

3. The driver according to claim 1,
wherein time required until the positioning member abuts again on the push lever is longer than time required until the movable body reaches a bottom dead center.

4. The driver according to claim 2,
wherein time required until the positioning member abuts again on the push lever is longer than time required until the movable body reaches a bottom dead center.

5. The driver according to claim 1,
wherein a first engagement part and a second engagement part are provided in the push lever at two different positions along a moving direction of the push lever,
a bias member which always biases the push lever toward the restricting position is engaged with the first engagement part, and
the positioning member abuts on the second engagement part.

6. The driver according to claim 2,
wherein a first engagement part and a second engagement part are provided in the push lever at two different positions along a moving direction of the push lever,
a bias member which always biases the push lever toward the restricting position is engaged with the first engagement part, and
the positioning member abuts on the second engagement part.

7. The driver according to claim 3,
wherein a first engagement part and a second engagement part are provided in the push lever at two different positions along a moving direction of the push lever,
a bias member which always biases the push lever toward the restricting position is engaged with the first engagement part, and
the positioning member abuts on the second engagement part.

8. The driver according to claim 4,
wherein a first engagement part and a second engagement part are provided in the push lever at two different positions along a moving direction of the push lever,
a bias member which always biases the push lever toward the restricting position is engaged with the first engagement part, and
the positioning member abuts on the second engagement part.

9. The driver according to claim 1,
wherein the positioning member includes: a flange part disposed in a sub-cylinder in which an elastic body is housed; and
a shaft part having one end connected to the flange part and the other end protruding from the sub-cylinder and abutting on the push lever, and
the positioning member is displaced by the pressure of fluid supplied into the sub-cylinder against bias of the elastic body.

10. The driver according to claim 9,
wherein the fluid supplied into the sub-cylinder is a part of the fluid supplied into the main cylinder.

11. A driver comprising:
a main body;
a movable body which is reciprocably provided in the main body and strikes a fastener; and
a push lever which is provided in the main body so as to be movable between a top dead center and a bottom dead center,
wherein the push lever can move to a position lower than that before starting a driving operation, simultaneously with or immediately after starting the driving operation.

12. The driver according to claim 11,
wherein the bottom dead center of the push lever returns to a position before starting the driving operation when the driving operation is completed.
